(19) United States
(12) Patent Application Publication
(10) Pub. No.: US 2012/0185401 A1
(43) Pub. Date: Jul. 19, 2012

(54) System and Method for Preparing Flat/Fixed Fee Legal Services

(76) Inventor: Randall W. Marusyk, Ottawa (CA)

(21) Appl. No.: 13/325,628

(22) Filed: Dec. 14, 2011

Related U.S. Application Data
(60) Provisional application No. 61/422,739, filed on Dec. 14, 2010.

(51) Int. Cl. G06Q 50/18

(52) U.S. Cl. 705/311

(57) ABSTRACT

A system and method for providing flat/fixed fee legal services. The method comprises, creating a database detailing a plurality of legal services, each legal services associated with at least X. number of service options and/or attributes, and each of the at least X number of service options and/or attributes has a fixed fee (flat rate pricing); interfacing a client with the database such that the client selects a legal service; prompting the client to select service options and/or attributes; and providing a fixed fee based on the selected legal service, options and/or attributes.

### FIELD OF THE INVENTION

The present invention pertains to the legal service field and in particular to a system and method for providing flat/fixed fee legal services.

### BACKGROUND OF THE INVENTION

A major driver in choosing a service provider is not only cost but predictability of the costs. Many service industries to facilitate cost predictability have moved towards a flat or fixed fee structure in which a fixed fee is charged for a service rendered. Legal services, in particular those related to intellectual property and litigation, because of the varied nature of the work have not previously been amendable to a flat or fixed fee pricing structure.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for providing flat/fixed fee legal services. In accordance with an aspect of the present invention, there is provided a method for utilizing a tiered flat rate pricing structure for providing legal services, comprising: a) Creating a database detailing a plurality of legal services, each legal services associated with at least X number of service options and/or attributes, wherein each of the at least X number of service options and/or attributes has a fixed fee (flat rate pricing); b) interfacing a client with the database such that the client selects a legal service; c) prompting the client to select service options and/or attributes; d) providing a fixed fee based on the selected legal service, options and/or attributes.

### BRIEF DESCRIPTION OF THE DRAWINGS

These and other features of the invention will become more apparent in the following detailed description in which reference is made to the appended drawings.

FIG. 1 presents a table detailing pricing tiers

### DETAILED DESCRIPTION OF THE INVENTION

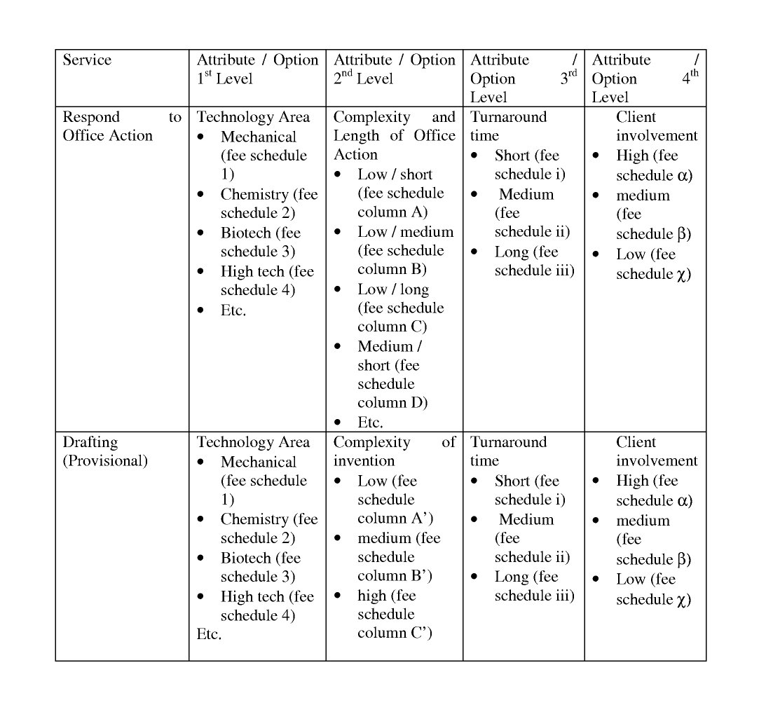

Referring to FIG. 1, illustrates one embodiment of the pricing tiers of flat rate pricing structure for providing legal services. A database is provided detailing a plurality of legal services. In one embodiment, the first tier of the flat rate pricing structure relates to the type of service being provided. In this embodiment, each legal service in the database is associated with a number of service options and/or attributes. These service options and/or attributes optionally relate to the nature of the product or service provided, the level of service provider client interaction action anticipated, the sophistication of the client, turn around time, etc. Optionally, individual attributes or options are ranked or weighted such that a specific attribute effects the total price to a greater extended than a second option.

In order to determine a flat rate pricing, a client interfaces with the system and selects the type of legal service required. For example, in an intellectual property context, the client initially identifies the type of IP, i.e. patent, trademark, copyright, industrial design, etc. After selecting a type of IP, the client can then be prompted to further define the nature of the service. If for example, the client selected “patents”, in one embodiment, the client would then select if they are the rights holder or not. The available services could be further limited based on if the patent has or has not issued. If the client is sophisticated, an option of searching for a service and bypassing the query based determination of services is provided.

Once a legal service is identified, the client is provided with the opportunity to identify service options and/or attributes. As detailed in FIG. 1, service options and/or attributes may relate to the nature of the service, time frame, etc.

In one embodiment, for patents, flat fee pricing may in part reflect the speed in which a client wishes for prosecution of a patent application to proceed. Optionally, in such an embodiment, the system may interface with government systems of fast tracking or “slow boating” an application, such as that currently being considered by the USPTO. In such an embodiment, the system is optionally further linked to a docketing system such that matters are docketed in such a manner as to reflect the speed in which a client wisher for prosecution of a patent application to proceed.

In one embodiment, the system is optionally further linked to a system to determine application eligibility for various fast tracking options.

### EXAMPLE 1

### Determining Flat Fee=

For response to mechanical office action, medium complexity, short, short turn around time, client involvement medium.
→Fee would be determined from Office action fee schedule 1Diβ
→Other fixed fees could be added, i.e. fee attending to various formalities

### EXAMPLE 2

For drafting provisional application in biotech, low complexity, long turn around time with high client involvement
→Fee would be determined from provisional application fee schedule 3A′iiiα
→Other fixed fees could be added, i.e. fee for sequence listing, preparing figures

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A method for utilizing a tiered flat rate pricing structure for providing legal services, comprising:
a) Creating a database detailing a plurality of legal services, each legal services associated with at least X number of service options and/or attributes, wherein each of the at least X number of service options and/or attributes has a fixed fee (flat rate pricing);
b) Interfacing a client with the database such that the client selects a legal service;
c) Prompting the client to select service options and/or attributes;
d) Providing a fixed fee based on the selected legal service, options and/or attributes.

2. The method of claim 1, wherein step c) comprises selecting multiple options and/or attributes.
